(19) United States
(12) Patent Application Publication
(10) Pub. No.: US 2026/0230975 A1
(43) Pub. Date: Aug. 6, 2026

(54) ELECTRONIC APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: KEI TAKARABE, Kanagawa (JP)

(21) Appl. No.: 19/578,710

(22) Filed: Mar. 25, 2026

Related U.S. Application Data
(63) Continuation of application No. PCT/JP2024/034068, filed on Sep. 25, 2024.

(30) Foreign Application Priority Data
Sep. 26, 2023 (JP) 2023-163585

(51) Int. Cl. H04W 36/08; H04W 48/08; H04W 48/20

(52) U.S. Cl. CPC H04W 36/08; H04W 48/08; H04W 48/20

(57) ABSTRACT

An electronic apparatus performs: performing control to change a connection target access point (AP) based on receiving, from a currently connected AP, a connection target change request for changing a connection target; detecting service set identifiers (SSIDs) of APs in a vicinity based on wireless signals received from the APs; and when a connection target AP is to be set, when one or more predetermined conditions including a condition that APs having the same SSID are detected are satisfied, performing control to display a selection screen for selecting between a first option for a user to designate a connection target from among the APs, and a second option for enabling switching of the connection target among the APs, wherein the selection screen includes a specific display for prompting the user to select the second option.

### CROSS-REFERENCE TO RELATED APPLICATIONS

This application is a Continuation of International Patent Application No. PCT/JP 2024/034068, filed Sep. 25, 2024, which claims the benefit of Japanese Patent Application No. 2023-163585, filed Sep. 26, 2023, both of which are hereby incorporated by reference herein in their entirety.

### BACKGROUND

### Field of the Technology

The present disclosure relates to an electronic apparatus capable of establishing a wireless LAN connection, a control method, and a non-transitory computer-readable storage medium.

### Description of the Related Art

For an extended service set (ESS) constituted by a plurality of access points (APs), there is a technology for dynamically switching between connection target APs in order to efficiently exchange data between the APs and a station (STA). When it is determined that the connection target AP is to be switched to another AP based on the congestion of the AP to which the STA is connected, the availability of the other APs, the radio wave conditions, and so on, the currently connected AP transmits a connection AP change request to the STA. When the STA receives an AP change request, the STA can connect to an appropriate AP by switching the connection target AP according to the request.

Japanese Patent Laid-Open No. 2021-175068 discloses the following processing as processing in which a router with AP functions requests that a wireless adapter device connected thereto change the connection target. A mobile router (MR1) that is capable of connecting to a plurality of wireless adapter devices checks whether or not a wireless adapter terminal is compatible with the IEEE 802.11v. Whether or not a wireless adapter terminal is compatible with IEEE 802.11v standard can be determined from an Association Request frame that the wireless adapter terminal transmits when wirelessly connecting to the MR1. When the wireless adapter terminal is compatible with the IEEE 802.11v standard, a BSS transition management (BTM) Request frame is transmitted to the wireless adapter terminal. The BSS Transition Candidate List Entries field of the BTM Request frame specifies the BSSID of a base station router RT2 as the connection target. As a result, the wireless adapter terminal is prompted to switch the connection target, and the wireless adapter terminal switches the connection target from the MR1 to the RT2 according to the received BTM Request frame.

Japanese Patent Laid-Open No. 2013-161250 discloses a method for, in cases where there exists a plurality of pieces of connection information that differ in communication parameters but contain the same information regarding the counterpart device, displaying only a single selection option instead of repeatedly displaying the information regarding the counterpart device.

Japanese Patent Laid-Open No. 2021-175068 describes processing performed to change a connection target of the STA in cases where an AP determines that the STA supports IEEE 802.11v, but makes no mention of detailed operations of the STA. For example, while there may exist cases where a user is unaware of the specification for automatic connection target change using IEEE 802.11v, or where a user is aware of the specification but does not desire the connection target to be changed automatically, operations in such cases are not described.

Japanese Patent Laid-Open No. 2013-161250 describes a screen display method in cases where there exists a plurality of pieces of connection information that differ in communication parameters but contain the same information regarding the counterpart device, but makes no mention of screen display in cases where the counterpart device supports IEEE 802.11v.

### SUMMARY

An object of the present disclosure is to provide a technique for enabling a user to easily connect an electronic apparatus to an AP that provides a better communication environment.

An electronic apparatus according to the present disclosure includes: at least one memory and at least one processor which function as: a communication control unit configured to perform control to change a connection target access point (AP) based on receiving, from a currently connected AP, a connection target change request for changing a connection target; a detection unit configured to detect service set identifiers (SSIDs) of APs in a vicinity based on wireless signals received from the APs in the vicinity; and a display control unit configured to, when a connection target AP is to be set, in a case where one or more predetermined conditions including a condition that a plurality of APs having the same SSID are detected by the detection unit are satisfied, perform control to display a selection screen for selecting between a first option for a user to designate a connection target from among the plurality of APs, and a second option for enabling the communication control unit to switch the connection target among the plurality of APs, wherein the display control unit provides a predetermined display on the selection screen to prompt the user to select the second option.

According to the present disclosure, it is possible to provide a technique for enabling a user to easily connect to an AP that provides a better communication environment.

Features of the present disclosure will become apparent from the following description of embodiments with reference to the attached drawings.

Other features and advantages of the present disclosure will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of present disclosure and, together with the description, serve to explain principles of the present disclosure.

FIG. 1 is a diagram showing a system configuration;

FIG. 2A is a diagram showing a configuration of an MFP;

FIG. 2B is a diagram showing a configuration of the MFP;

FIG. 3A is a diagram showing an operation display unit of the MFP;

FIG. 3B is a diagram showing the operation display unit of the MFP;

FIG. 3C is a diagram showing the operation display unit of the MFP;

FIG. 4A is a diagram showing a configuration of a mobile terminal device;

FIG. 4B is a diagram showing a configuration of the mobile terminal device;

FIG. 5 is a diagram showing a configuration of an access point;

FIG. 6 is a sequence diagram illustrating processing that is performed in response to a connection target change request from an AP;

FIG. 7A is a flowchart illustrating switching of a screen display when a plurality of APs having the same ESSID are detected.

FIG. 7B is a flowchart illustrating switching of a screen display when a plurality of APs having the same ESSID are detected.

FIG. 7C is a flowchart illustrating switching of a screen display when a plurality of APs having the same ESSID are detected.

FIG. 8A is a diagram illustrating an example of a screen display when a plurality of APs having the same ESSID are detected.

FIG. 8B is a diagram illustrating an example of a screen display when a plurality of APs having the same ESSID are detected.

FIG. 8C is a diagram illustrating an example of a screen display when a plurality of APs having the same ESSID are detected.

FIG. 8D is a diagram illustrating an example of a screen display when a plurality of APs having the same ESSID are detected.

FIG. 8E is a diagram illustrating an example of a screen display when a plurality of APs having the same ESSID are detected.

FIG. 8F is a diagram illustrating an example of a screen display when a plurality of APs having the same ESSID are detected.

FIG. 8G is a diagram illustrating an example of a screen display when a plurality of APs having the same ESSID are detected.

FIG. 8H is a diagram illustrating an example of a screen display when a plurality of APs having the same ESSID are detected.

FIG. 8I is a diagram illustrating an example of a screen display when a plurality of APs having the same ESSID are detected.

FIG. 8J is a diagram illustrating an example of a screen display when a plurality of APs having the same ESSID are detected.

FIG. 8K is a diagram illustrating an example of a screen display when a plurality of APs having the same ESSID are detected.

FIG. 8L is a diagram illustrating an example of a screen display when a plurality of APs having the same ESSID are detected.

FIG. 8M is a diagram illustrating an example of a screen display when a plurality of APs having the same ESSID are detected.

FIG. 8N is a diagram illustrating an example of a screen display when a plurality of APs having the same ESSID are detected.

FIG. 8O is a diagram illustrating an example of a screen display when a plurality of APs having the same ESSID are detected.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration

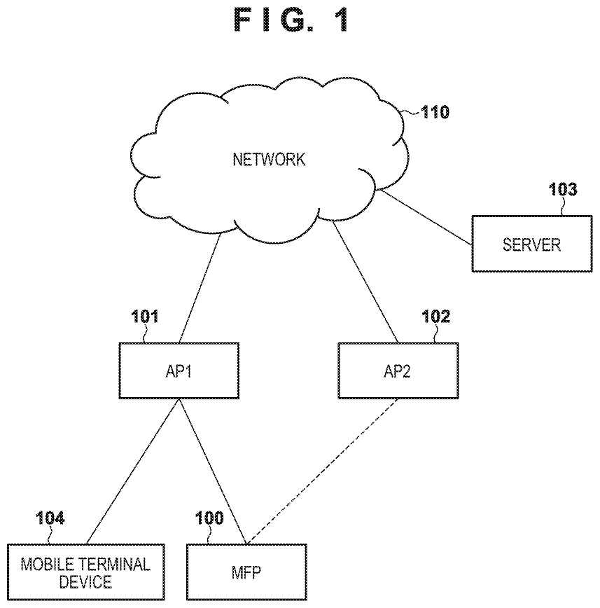

FIG. 1 shows an example of a configuration of a system according to the present embodiment. In one example, the present system is a wireless communication system in which a plurality of communication devices can communicate wirelessly with each other. In the example in FIG. 1, the system includes, as communication devices, a mobile terminal device 104, an electronic apparatus (MFP) 100, APs 101 and 102, which are access points, a server 103, and a network 110. Note that the AP 101 and the AP 102 may be illustrated as an AP1 and an AP2. The mobile terminal device 104 is an example of an information processing apparatus that has a wireless communication function using a wireless LAN or the like. Hereinafter, the wireless LAN may also be referred to as a WLAN. The mobile terminal device 104 may be a personal information terminal such as a personal digital assistant (PDA), a mobile phone (smartphone), a digital camera, a personal computer, or the like.

The MFP 100 is an example of an electronic apparatus according to the present embodiment, and is a multi-function printer that has a printing function and may also have a reading function (scanner), a FAX function, and a telephone function. In addition, the MFP 100 according to the present embodiment has a communication function that enables the MFP 100 to perform wireless communication with the mobile terminal device 104. Although the present embodiment describes an example in which the MFP 100 is used, the present embodiment is not limited to such an example. For example, a scanner device, a projector, a mobile terminal, a smartphone, a laptop PC, a tablet terminal, a PDA, a digital camera, a music playback device, a television, a smart speaker, or the like each having a communication function may be used instead of the MFP 100. Note that “MFP” is an acronym for a Multi Function Peripheral.

The AP 101 is provided separately (externally) from the mobile terminal device 104 and the MFP 100 and operates as a WLAN base station device. A communication device having a WLAN communication function can perform communication in WLAN infrastructure mode via the AP 101. Hereinafter, each access point may be referred to as an “AP”. In addition, the infrastructure mode may be referred to as a “wireless infrastructure mode”. The AP 101 performs wireless communication over a network with an (authenticated) communication device that is permitted to connect to the AP 101, and relays wireless communication between the communication device and another communication device. In addition, the AP 101 is connected to, for example, a wired communication network, and can relay communication between a communication device connected to the wired communication network and another communication device wirelessly connected to the AP 101.

The AP 102 has the same functions as the AP 101, and the MFP 100 switches the connection target from the AP 101 to the AP 102 as necessary. The server 103 connects to the MFP 100 via the AP 101 and the network 110 and provides services to the MFP 100 in response to requests from the MFP 100. Here, the network 110 may be the so-called Internet, a closed network within a company, or a mobile phone network.

### External Configuration of MFP

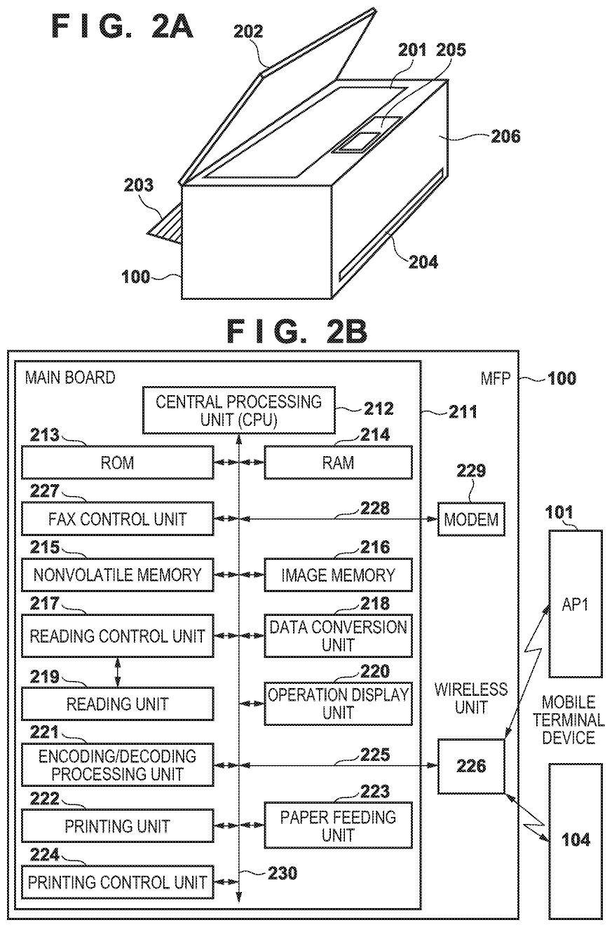

FIG. 2A shows an example of an external configuration of the MFP 100. The MFP 100 includes, for example, a document table 201, a document cover 202, a printing paper insertion port 203, a printing paper discharge port 204, and an operation display unit 205. The document table 201 is a table on which a document to be read is placed. The document cover 202 is a cover that holds the document placed on the document table 201 and prevents light from a light source that illuminates the document during reading from leaking to the outside. The printing paper insertion port 203 is an insertion port into which paper of various sizes can be set. The printing paper discharge port 204 is a discharge port from which sheets of paper that have been printed are discharged. The sheets of paper set in the printing paper insertion port 203 are conveyed one by one to the printing unit, and after printing is performed in the printing unit, they are discharged from the printing paper discharge port 204. The operation display unit 205 includes keys such as character input keys, a cursor key, an enter key, and a cancel key, as well as an LED, an LCD, and so on, and is configured to be able to accept activation of various functions of the MFP and operation of various settings performed by the user. The operation display unit 205 may also include a touch panel display. The MFP 100 has a wireless communication function using a WLAN and includes a wireless communication antenna 206 for wireless communication, which does not necessarily have to be visible from the outside. As with the mobile terminal device 104, the MFP 100 can also perform wireless communication in the 2.4 GHz band and the 5 GHz frequency band using a WLAN.

### Configuration of MFP

FIG. 2B shows an example of a configuration of the MFP 100. The MFP 100 includes a main board 211 that performs main control on the MFP 100 itself, and a wireless unit 226, which is one communication module that performs WLAN communication using at least one shared antenna. In addition, the MFP 100 includes a modem 229 for wired communication, for example. The main board 211 includes, for example, a central processing unit (CPU) 212, a ROM 213, a RAM 214, a nonvolatile memory 215, an image memory 216, a reading control unit 217, a data conversion unit 218, a reading unit 219, and an encoding/decoding processing unit 221. In addition, the main board 211 includes, for example, a printing unit 222, a paper feeding unit 223, a printing control unit 224, and an operation display unit 220. These functional units within the main board 211 are interconnected via a system bus 230 managed by the CPU 212. The main board 211 and the wireless unit 226 are connected, for example, via a dedicated bus 225, and the main board 211 and the modem 229 are connected, for example, via a bus 228.

The CPU 212 is a system control unit that includes at least one processor and controls the entire MFP 100. In one example, the processing performed by the MFP 100 described below is realized by the CPU 212 executing a program stored in the ROM 213. Note that dedicated hardware for each kind of processing may be provided. The ROM 213 is an example of a computer-readable storage medium that stores control programs, a built-in OS program, and so on executed by the CPU 212. In the present embodiment, the CPU 212 performs software control such as scheduling and task switching by executing each control program stored in the ROM 213 under the management of the built-in OS also stored in the ROM 213.

The RAM 214 is constituted by an SRAM or the like. The RAM 214 stores data such as program control variables, setting values registered by the user, and management data of the MFP 100. The RAM 214 may also be used as various kinds of work buffers. The nonvolatile memory 215 is constituted by a memory such as a flash memory and continues to store data even when the MFP 100 is turned off. The image memory 216 is constituted by a memory such as a DRAM. The image memory 216 stores image data received via the wireless unit 226, image data processed by the encoding/decoding processing unit 221, and so on. Note that the memory configuration of the MFP 100 is not limited to the above configuration. The data conversion unit 218 analyzes data in various formats and converts image data to print data, for example.

The reading control unit 217 controls the reading unit 219 (for example, a contact image sensor (CIS)) to optically read a document placed on the document table 201. The reading control unit 217 converts an image obtained by optically reading a document into electrical image data (image signal) and outputs the image data. At this time, the reading control unit 217 may output the image data after performing various image processing such as binarization processing and halftone processing on the image data.

The operation display unit 220 is the operation display unit 205 described with reference to FIG. 2A and performs display on the display based on display control performed by the CPU 212, generates signals in response to acceptance of user operations, and so on.

The encoding/decoding processing unit 221 performs encoding processing, decoding processing, and scaling processing on image data (JPEG, PNG, etc.) handled by the MFP 100.

The paper feeding unit 223 stores sheets of paper for printing. The paper feeding unit 223 can supply the sheets of paper that have been set, under the control of the printing control unit 224. The paper feeding unit 223 may include a plurality of paper feeding units in order to store a plurality of types of paper in one device, and it is possible to perform control as to from which paper feeding unit paper is to be supplied, under the control of the printing control unit 224.

The printing control unit 224 performs various kinds of image processing such as smoothing processing, print density correction processing, and color correction on the image data to be printed, and outputs the processed image data to the printing unit 222. The printing unit 222 is configured to be able to perform, for example, inkjet recording printing processing, and records an image on a recording medium such as paper by ejecting ink supplied from an ink tank from a print head. Note that the printing unit 222 may be configured to be able to execute other kinds of printing processing such as electrophotography printing processing. The printing control unit 224 can periodically read out information regarding the printing unit 222 and update status information stored in the RAM 214, including the remaining amount of ink in the ink tank, the status of the print head, and so on.

The wireless unit 226 is a unit that can provide a WLAN communication function and can provide the same function as a combination of a WLAN unit 429 of the mobile terminal device 104, for example. That is, the wireless unit 226 converts data into packets and transmits the packets to another device in accordance with the WLAN standard and restores packets from another external device to original data and outputs the restored data to the CPU 212. The wireless unit 226 can perform communication as a station compliant with the IEEE 802.11 standard series. In particular, the wireless unit 226 can perform communication as a station compliant with the IEEE 802.11a/b/g/n/ac/ax. Hereinafter, the station may also be referred to as an STA. In addition, the wireless unit 226 can perform communication as an STA compatible with Wi-Fi Agile Multiband (registered trademark).

The wireless unit 226 is compatible with the IEEE 802.11ax, i.e., Wi-Fi6 (trademark), and the MFP 100 can also operate as an STA compatible with at least one of the orthogonal frequency-division multiple access (OFDMA) and the target wake time (TWT). The wireless unit 226 is compatible with the TWT, and therefore the timing of data communication from the base station device to the STA can be adjusted. The wireless unit 226 (MFP 100) serving as the STA causes the communication function thereof to enter a sleep state when there is no need to wait for signal reception. In this way, it is possible to reduce power consumption. The wireless unit 226 is also compatible with Wi-Fi 6E (trademark). In other words, the wireless unit 226 can also perform communication in the 6 GHz band (5.925 GHz to 7.125 GHz). The target band for dynamic frequency selection (DFS), which exists in the 5 GHz band, does not exist in the 6 GHz band. Therefore, communication using the 6 GHz band will not be interrupted by DFS standby time, and more comfortable communication can be expected.

Note that the mobile terminal device 104 and the MFP 100 can perform P2P (WLAN) communication based on the WFD, and the wireless unit 226 has a software access point (soft AP) function or a group owner function. In other words, the wireless unit 226 can establish a network for P2P communication and determine a channel to be used for P2P communication.

### Operation Display Unit of MFP

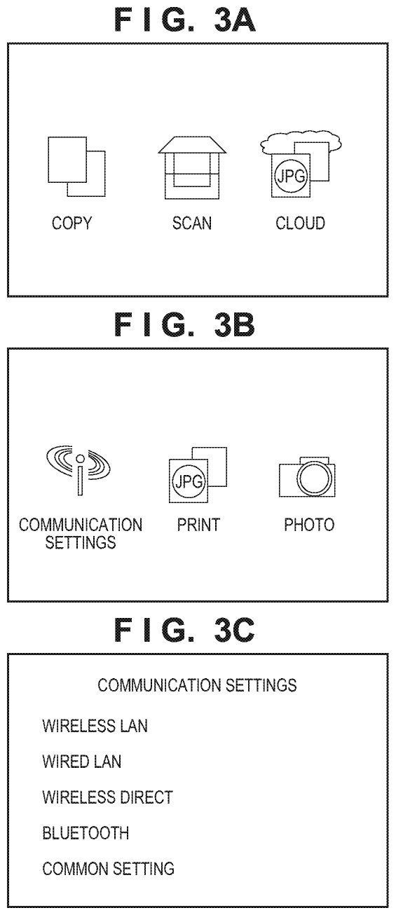

FIG. 3A to 3C schematically show examples of screen displays on a display (touch panel display) included in the operation display unit 220 of the MFP 100. FIG. 3A is an example of a home screen displayed when the MFP 100 is turned on and not performing an operation such as printing or scanning (an idle state, a standby state). In FIG. 3A, display items (menu items) corresponding to Copy, Scan, and Cloud are displayed. Cloud is a menu item related to cloud functions using Internet communication. When any of the menu items is selected through key operation or touch panel operation, the MFP 100 can start performing the setting or function corresponding thereto. The MFP 100 can seamlessly display a screen different from that shown in FIG. 3A by accepting a key operation or a touch panel operation on the home screen shown in FIG. 3A.

FIG. 3B is an example of a display of another portion of the home screen, and is a screen transitioned from that in the state shown in FIG. 3A in response to an operation performed to display another page of the home screen (such as a slide operation to the left or the right). In FIG. 3B, display items (menu items) corresponding to Communication Settings, Print, and Photo are displayed. When any of these menu items is selected, the function corresponding to the selected menu item, i.e., the print function, photo function, or communication setting, is performed.

FIG. 3C is an example of a display of a communication setting menu screen displayed when Communication Setting is selected on the screen shown in FIG. 3B. On the communication setting menu screen, “Wireless LAN”, “Wired LAN”, “Wireless Direct”, “Bluetooth”, and “Common” are displayed as menu items (options). “Wireless LAN”, “Wired LAN”, and “Wireless Direct” are menu items for LAN settings. For example, the wired connection settings, settings for enabling/disabling a wireless infrastructure mode, and settings for enabling/disabling a P2P mode such as the WFD and the soft AP mode, and so on can be performed using these items. When the item “Wireless LAN” is selected and a wireless LAN is enabled through a user operation, the wireless infrastructure mode is enabled. When the item “Wireless Direct” is selected and the wireless direct is enabled through a user operation, the P2P (WLAN) mode is enabled. This screen also displays a common setting menu for each form of connection. Furthermore, the user can set the wireless LAN frequency band, frequency channel, and so on from this screen.

### External Configuration of Mobile Terminal Device

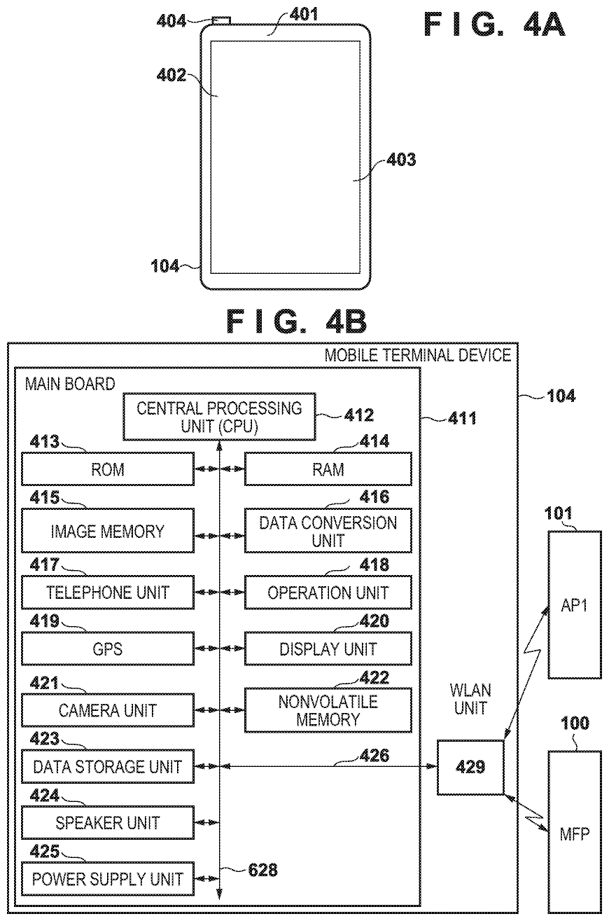

FIG. 4A is a diagram showing an example of an external configuration of the mobile terminal device 104. The present embodiment shows an example in which the mobile terminal device 104 is a typical smartphone. Note that the mobile terminal device 104 includes, for example, a display unit 402, an operation unit 403, and a power key 404. The display unit 402 is, for example, a display that includes a liquid crystal display (LCD) type display mechanism. Note that the display unit 402 may display information using, for example, a light emitting diode (LED). In addition to or instead of the display unit 402, the mobile terminal device 104 may have the function of outputting information by voice. The operation unit 403 includes physical keys such as keys and buttons, a touch panel, and so on for detecting user operations. Note that in the present example, a shared touch panel display is used to display information on the display unit 402 and to accept user operations performed on the operation unit 403, and therefore the display unit 402 and the operation unit 403 are realized using a single device. In this case, for example, a button icon or a software keyboard is displayed using the display function of the display unit 402, and the operation acceptance function of the operation unit 403 detects that the user has touched these parts. Note that the display unit 402 and the operation unit 403 may be separated, and hardware for display and hardware for operation reception may be separately provided. The power key 404 is a physical key for accepting user operations for turning on or off the mobile terminal device 104.

The mobile terminal device 104 includes a WLAN unit 401 that provides a WLAN communication function, which does not necessarily have to be visible from the outside. The WLAN unit 401 is configured to be able to perform data (packet) communication in a WLAN system compliant with, for example, the IEEE 802.11 standard series (IEEE 802.11a/b/g/n/ac/ax, etc.). In addition, the WLAN unit 401 can perform communication as an AP compatible with Wi-Fi Agile Multiband (registered trademark). However, the WLAN unit 401 is not limited to having such a configuration and may be capable of performing communication in a WLAN system compliant with other standards. In the present example, it is assumed that the WLAN unit 401 is capable of performing communication in both the 2.4 GHz and 5 GHz frequency bands. It is also assumed that the WLAN unit 401 is capable of performing WFD-based communication, soft AP mode communication, wireless infrastructure mode communication, and so on. Operations in these modes will be described later.

### Configuration of Mobile Terminal Device

FIG. 4B shows an example of a configuration of the mobile terminal device 104. In one example, the mobile terminal device 104 includes a main board 411 that performs main control on the mobile terminal device 104 itself, and a WLAN unit 429 that performs WLAN communication. The main board 411 includes, for example, a CPU 412, a ROM 413, a RAM 414, an image memory 415, a data conversion unit 416, a telephone unit 417, a GPS 419, a camera unit 421, a nonvolatile memory 422, a data storage unit 423, a speaker unit 424, and a power supply unit 425. Here, CPU is an acronym for Central Processing Unit, ROM is for Read Only Memory, RAM is for Random Access Memory, and GPS is for Global Positioning System. The mobile terminal device 104 includes a display unit 420 and an operation unit 418. These functional units within the main board 411 are interconnected via a system bus 628 managed by the CPU 412. In addition, the main board 411 and the WLAN unit 429 are connected via a dedicated bus 426, for example.

The CPU 412 is a system control unit that includes at least one processor and controls the entire mobile terminal device 104. In one example, the processing performed by the mobile terminal device 104 described below is realized by the CPU 412 executing a program stored in the ROM 413. Note that dedicated hardware for each kind of processing may be provided. The ROM 413 stores control programs, built-in operating system (OS) programs, and so on executed by the CPU 412. In the present embodiment, the CPU 412 performs software control such as scheduling and task switching by executing each control program stored in the ROM 413 under the management of the built-in OS also stored in the ROM 413.

The RAM 414 is constituted by a static RAM (SRAM) or the like. The RAM 414 stores data such as program control variables, setting values registered by the user, and management data of the mobile terminal device 104. The RAM 414 may also be used as various kinds of work buffers. The image memory 415 is constituted by a memory such as a dynamic RAM (DRAM). The image memory 415 temporarily stores image data received via the WLAN unit 429 and image data read out from the data storage unit 423 in order to enable the CPU 412 to process such data. The nonvolatile memory 422 is constituted by a memory such as a flash memory and continues to store data even when the mobile terminal device 104 is turned off. Note that the memory configuration of the mobile terminal device 104 is not limited to the above-described configuration. For example, the image memory 415 and the RAM 414 may be shared, or the data storage unit 423 may be used to back up data. In addition, although a DRAM is used as an example of the image memory 415 in the present embodiment, another storage medium such as a hard disk or a nonvolatile memory may be used.

The data conversion unit 416 analyzes data in various formats and performs data conversion such as color conversion and image conversion. The telephone unit 417 controls the telephone line and processes voice data input and output via the speaker unit 424, thereby realizing communication by telephone. The GPS 419 receives radio waves transmitted from a satellite and acquires the current position information such as the latitude and the longitude of the mobile terminal device 104.

The camera unit 421 has the function of electronically recording and encoding an image input through a lens. Image data acquired through image capturing performed by the camera unit 421 is stored in the data storage unit 423. The speaker unit 424 performs control to realize the function of inputting or outputting voices for the telephone function, and other functions such as alarm notification. The power supply unit 425 is, for example, a portable battery, and controls power supply to the inside of the device. Examples of power states include an empty battery state where there is no battery power remaining, a power off state where the power key 404 has not been pressed, an active state where the device is normally active, and a power saving state where the device is active, but power consumption is reduced. The display unit 420 is the display unit 402 described with reference to FIG. 4A, and displays various input operations, the operation state of the MFP 100, and a status, for example, under the control of the CPU 412. The operation unit 418 is the operation unit 403 described with reference to FIG. 4A. Upon receiving a user operation, the operation unit 418 performs control to, for example, generate an electrical signal corresponding to the operation and output the signal to the CPU 412.

The mobile terminal device 104 performs wireless communication using the WLAN unit 429 to perform data communication with another device such as the MFP 100. The WLAN unit 429 converts data into packets and transmits the packets to another device. In addition, the WLAN unit 429 restores packets transmitted from another external device to original data and outputs the original data to the CPU 412. The WLAN unit 429 is a unit for realizing communication compliant with each WLAN standard. The WLAN unit 429 can operate in at least two communication modes in parallel, including the wireless infrastructure mode and the P2P (WLAN) mode. Note that the frequency bands used in these communication modes may be limited by the functions and performance of the hardware.

### Configuration of Access Point

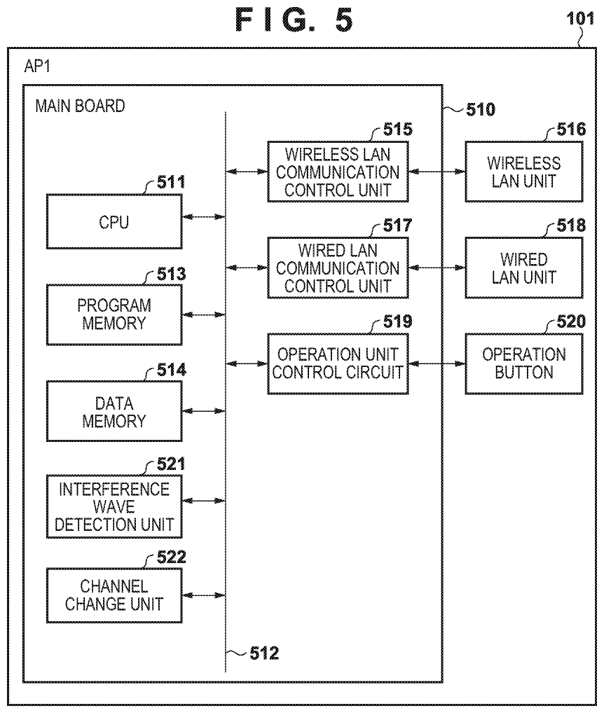

FIG. 5 is a block diagram showing a configuration of the AP 101 having a wireless LAN access point function. The AP 101 includes a main board 510 that controls the AP 101, a wireless LAN unit 516, a wired LAN unit 518, and an operation button 520.

A CPU 511, which is in the form of a microprocessor disposed on the main board 510, operates according to a control program stored in a program memory 513, which is in the form of a ROM connected via an internal bus 512, and the content of a data memory 514, which is in the form of a RAM. The CPU 511 performs wireless LAN communication with another communication terminal device by controlling the wireless LAN unit 516 through a wireless LAN communication control unit 515. The CPU 511 performs wired LAN communication with another communication terminal device by controlling the wired LAN unit 518 through a wired LAN communication control unit 517. The CPU 511 can accept operations from the user operating the operation button 520 by controlling an operation unit control circuit 519. The CPU 511 includes at least one processor.

The AP 101 includes an interference wave detection unit 521 and a channel change unit 522. The interference wave detection unit 521 performs interference wave detection processing when wireless communication is performed using a band for which dynamic frequency selection (DFS) is performed. The channel change unit 522 performs processing to change the band to be used when it is necessary to immediately change to a free channel when an interference wave is detected while performing wireless communication using a band for which DFS is performed.

Note that the AP 102 has the same configuration as the AP 101.

### P2P Communication Method

The following describes the P2P (WLAN) communication method in which devices directly communicate wirelessly with each other without using an external access point in WLAN communication. P2P (WLAN) communication can be realized using any of a plurality of schemes. For example, a communication device supports a plurality of modes for P2P (WLAN) communication and can selectively use any of the plurality of modes to perform P2P communication (WLAN).

The following two modes are considered as P2P modes:
Soft AP Mode
Wi-fi Direct (WFD) Mode

A communication device capable of performing P2P communications may be configured to support at least one of these modes. On the other hand, even a communication device capable of performing P2P communication does not have to support all of these modes and may be configured to support only some of them.

A communication device having a WFD communication function (for example, the mobile terminal device 104) accepts a user operation through the operation unit thereof to call an application (which may be a dedicated application) for realizing the communication function. Thereafter, this communication device can display a user interface (UI) screen provided by the application to prompt the user to input an operation and perform WFD communication based on the user operation accepted in response. -Soft AP Mode

In the soft AP mode, a communication device (for example, the mobile terminal device 104) operates as a client that requests various services. The other communication device (for example, the MFP 100) operates as a soft AP that can perform the functions of a WLAN AP using software settings. Note that the commands and parameters transmitted and received when establishing a wireless connection between the client and the soft AP need only be those specified in the Wi-Fi (registered trademark) standard, and therefore the descriptions thereof are omitted here. The MFP 100 operating in the soft AP mode determines the frequency band and the frequency channel as a base station. Therefore, the MFP 100 can select which frequency band to use, 5 GHz or 2.4 GHz, and which frequency channel to use with this frequency band.

### WFD Mode

The MFP 100 may be activated permanently as a base station in the WFD mode (Autonomous Group Owner). In this case, there is no need to perform GO Negotiation processing to determine the role. In addition, in this case, the MFP 100 determines the frequency band and the frequency channel as a base station. Therefore, the MFP 100 can select which frequency band to use, 5 GHz or 2.4 GHz, and which frequency channel to use with this frequency band.

### Wireless Infrastructure Mode

In the wireless infrastructure mode, communication devices that communicate with each other (for example, the mobile terminal device 104 and the MFP 100) are connected to an external AP (for example, the AP 101) that controls the network overall, and communication between the communication devices is performed through the AP. In other words, communication between communication devices is performed through the network established by the external AP. The mobile terminal device 104 and the MFP 100 each discover the AP 101 and connect to the AP 101 by transmitting a connection request thereto, and as a result, these communication devices can communicate through the AP 101 in the wireless infrastructure mode. Note that each of a plurality of communication devices may connect to a different AP. In this case, data transfer between the APs enables communication between the communication devices. Note that the commands and parameters transmitted and received when the communication devices communicate with each other through the access point need only be those specified in the Wi-Fi standard, and therefore the descriptions thereof are omitted here. In addition, in this case, the AP 101 determines the frequency band and the frequency channel. Therefore, the AP 101 can select which frequency band to use, 5 GHz or 2.4 GHz or 6 GHz, and which frequency channel to use with this frequency band.

Processing Performed in Response to Change Request to Change Connection Target from AP to STA

The mobile terminal device 104 and the MFP 100 are compatible with the function published as Wi-Fi Agile Multiband (registered trademark). The Wi-Fi Agile Multiband is the function that makes it possible to select the optimal environment based on changing Wi-Fi network conditions. Specifically, STAs such as the mobile terminal device 104 and the MFP 100 and an AP such as the AP 101 exchange information regarding the network environment using the IEEE 802.11 series communication standard. Through such information exchange, the AP can redirect the STA (change the connection target) to another AP, frequency band, channel, or even another cellular service if the network is congested.

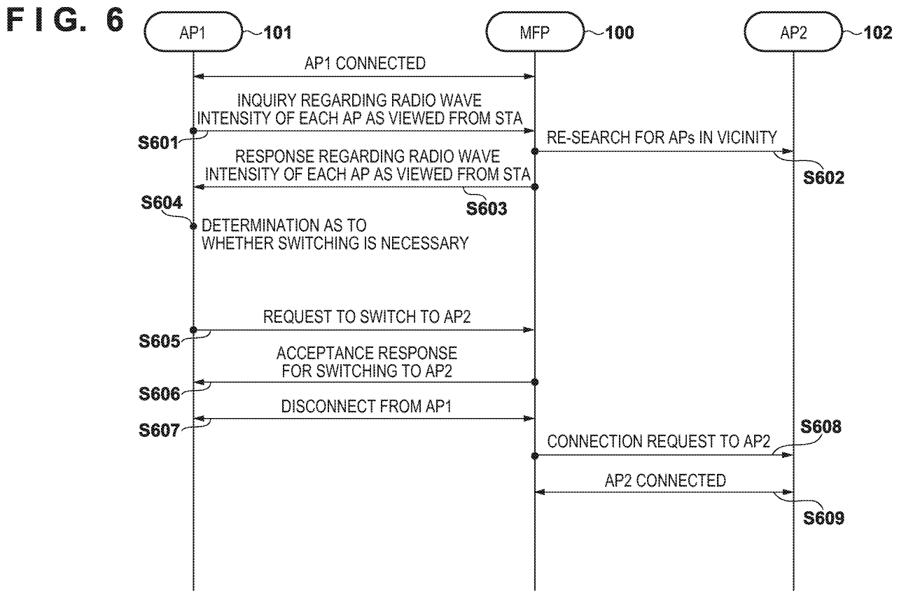

FIG. 6 is a sequence diagram in a case where the MFP 100 switches the connection target AP from the AP 101 to the AP 102 in response to a connection target change request from the AP 101. The processing performed by each device in this sequence is realized by the CPU included in the device reading out various programs stored in a memory such as a ROM included in the device to a RAM included in the device and executing the programs.

It is assumed that in the initial state of the processing in FIG. 6, the MFP 100 has established a connection to the AP 101 in the wireless infrastructure mode. It is also assumed that the AP 101 has acquired information regarding whether or not the MFP 100 is compatible with the IEEE 802.11v when the MFP 100 and the AP 101 connect to each other in the wireless infrastructure mode, and the AP 101 performs the following processing when the AP 101 has acquired information indicating that the MFP 100 is compatible with the IEEE 802.11v.

In step S601, the AP 101 transmits, to the MFP 100, an inquiry (a measurement request) regarding the measurement results of the communication quality between APs in the vicinity of the MFP 100 and the MFP 100. For example, a beacon frame request or a Beacon Report request may be included in the measurement request to be transmitted. That is to say, this request can be made using the mechanism specified in the IEEE 802.11k standard. In one example, the measurement request may be a measurement instruction that instructs the MFP 100 to measure the received signal strengths or signal-to-noise ratios of predetermined wireless signals such as beacon signals transmitted from APs in the vicinity of the MFP 100. In other words, the wireless unit 226 of the MFP 100 functions as a receiving unit that can receive a measurement request.

In step S602, in response to the request received in step S601, the MFP 100 receives frames transmitted from APs in the vicinity of the MFP 100 and measures the received signal strengths. As a result, the respective received signal strengths of the plurality of APs including the AP 101 and the AP 102 are measured. In one example, the MFP 100 may store measurement results regarding the frames transmitted by the APs in the vicinity of the MFP 100 in a storage device such as the RAM 214 or the nonvolatile memory 215. Therefore, the CPU 212 of the MFP 100 functions as a measuring unit that controls the wireless unit 226 and measures the communication quality with the access points in the vicinity of the MFP 100.

In step S603, the MFP 100 transmits a list of the received signal strengths of the signals from the APs in the vicinity of the MFP 100 measured in step S602 as a response to the request received in step S601. Note that the received signal strengths to be transmitted as a response may be information stored in the RAM 214 and the nonvolatile memory 215 of the MFP 100 in addition to, or instead of, the information measured in step S602. This response to be transmitted includes, for example, a Beacon Report or a Measurement Report.

In step S604, the AP 101 determines whether or not it is necessary to switch the connection target of the MFP 100, based on the congestion on the network that the AP 101 knows, and the received signal strength of the frame received from the MFP 100 in step S603. Factors that cause the AP 101 to determine that connection switching is necessary include a large number of connected STAs, a large amount of communication, other APs that are less congested, the presence or absence of radio interference, and AP function suspension. If the AP 101 determines that it is necessary to switch the connection target of the MFP 100 and determines the SSID of another AP to be designated as the switching target of the MFP 100, the channel, and the frequency band, processing proceeds to step S605.

In step S605, the AP 101 transmits a request to switch the connection target AP (change request) to the MFP 100. The connection target change request includes information determined in step S604 regarding the SSID of the other AP to be designated as the switching target of the MFP 100, the channel, and the frequency band. Note that a plurality of SSIDs may be designated. The connection target change request is transmitted as a BTM Request, for example. That is to say, a BSS transition management (BTM) Request frame specified in the IEEE 802.11v standard is transmitted. In the example in FIG. 6, it is assumed that the AP 102 is designated as the switching target included in the connection target change request. Therefore, the wireless unit 226 of the MFP 100 functions as a receiving unit that can receive a connection target change request.

In step S606, if the MFP 100 follows the connection target change request received in step S605, the MFP 100 transmits a response indicating acceptance of switching, to the AP 101. If the MFP 100 does not follow the connection target change request, the MFP 100 may transmit a switching rejection as a response. The response is transmitted as a BTM Response. In the example in FIG. 6, it is assumed that a response indicating acceptance of switching is transmitted.

In step S607, the AP 101 and the MFP 100 terminate the connection in the wireless infrastructure mode.

In step S608, the MFP 100 transmits a connection request to the AP 102 to connect to the AP 102 designated by the connection target change request received in step S605.

As a result, in step S609, a connection between the MFP 100 and the AP 102 is established in the wireless infrastructure mode.

With such a mechanism, the MFP 100, which is an STA, can change the connection target from the AP 101 to the AP 102 based on a connection target change request from the AP 101 to which the MFP 100 was originally connected. The AP 101 and the AP 102 may be APs installed at different locations. That is to say, through the processing in FIG. 6, the MFP 100 can switch to another AP installed at a different location from the AP to which the MFP 100 was originally connected. In addition, each AP may be compatible with a different frequency band of a plurality of frequency bands (any two or three of the 2.4 GHz band, the 5 GHz band, and the 6 GHz band) provided by the same device. That is to say, through the processing in FIG. 6, the MFP 100 can switch to another frequency band provided by the same device as the AP to which the MFP 100 was originally connected.

Here, there are cases where changing the currently connected AP based on a change request transmitted from the connected AP 101 causes no problem, and cases where changing the connected AP causes a problem.

For example, in a case where the MFP 100 is receiving print data, a problem may occur if the connected AP is changed based on a connection target switching request. During reception of print data by the MFP 100, a part of print data of an image to be printed has been received from the mobile terminal device 104 serving as a communication counterpart, whereas reception of the remaining part of the print data has not been completed. The MFP 100 does not store the entirety of the print data to be printed on one sheet of paper. Therefore, the MFP 100 performs printing by repeating a process of receiving a part of the print data and printing the received data (for example, receiving and printing one line of data), and then receiving subsequent data and printing that data. If the connection target AP is changed based on the connection target change request during reception of this print data, a time lag associated with connection target switching processing occurs, which may result in a deterioration in print quality such as uneven printing. In addition, after switching the connection target, communication with the mobile terminal device 104 serving as a communication counterpart may fail, making it impossible to receive subsequent data and resulting in a printing failure.

Another example is a case such as firmware update processing, in which the firmware update processing takes a long time because communication is temporarily interrupted due to switching of the connection target AP and communication is resumed after the connection target AP is switched.

As described above, in a situation where changing the connection target AP based on a connection target change request causes a problem, one or more of the following types of suppression processing can be performed in combination as processing for suppressing the change of the connection target in response to the change request (suppression processing). Each of the following types of suppression processing is processing for preventing the change of the connection target AP based on the connection target change request, or processing for suppressing the change.

### Suppression Processing 1

Even in a case where a change request is received in step S605, the MFP 100 may operate so as not to perform the change of the connection target AP based on the received connection target change request, and not to return a response to the change request (ignore the request). Alternatively, the MFP 100 can transmit, to the connected AP, a refusal response indicating a refusal of the change request (indicating that the change of the connection target AP is not performed). When the refusal response is transmitted, priority of changing the connection target of other STAs connected to the AP to which the MFP 100 is connected is increased, and priority of changing the connection target of the MFP 100 is lowered, so that the connection with the AP that has been connected can be maintained as a result. Further, in a case where a response is not returned (the request is ignored), the connected AP waits for a response until a predetermined standby time (response standby time) elapses after transmitting the change request, that is, until the response standby time times out. Therefore, the connected AP can maintain the connection with the MFP 100 at least until the response standby time times out. Accordingly, assuming a case where the connection is terminated immediately in response to receipt of some response to the change request from the MFP 100, not responding can prolong the time during which the connection with the connected AP can be maintained, compared to returning some response. Accordingly, for example, based on information regarding a change reason included in the change request, different processing can be performed depending on the reason, such as transmitting a refusal response if the reason is weak, and ignoring the request if the reason is strong.

For example, the change reason can be determined based on information included in a Request Mode included in a BTM Request, the information indicating which of several reasons is applicable. For example, in a case where a Disassociation Imminent bit or a BSS Termination Included bit of the Request Mode is set to 1, it can be determined that the change request has a strong change reason. Otherwise, it can be determined that the change request has a weak change reason.

### Suppression Processing 2

In response to the measurement request described in step S601, regarding a radio wave reception status (signal reception status) of a non-connected AP other than the connected AP, the MFP 100 responds with information indicating a worse radio wave status (poorer signal quality) than the actually measured status (returns a false response). In this case, in response to receipt of the measurement request, the MFP 100 may actually perform measurement and return a response, or may return a response without actually performing measurement. Specifically, in the response (Beacon Report or the like) described in step S603, with respect to the signal quality measured for a signal received from the non-connected AP, the MFP 100 responds with a value obtained by reducing the received signal strength, and/or responds with a value obtained by increasing the noise strength (signal-to-noise ratio). Alternatively, the response may have content that does not include information regarding at least one non-connected AP. In this case, the AP receiving the report interprets that the at least one AP not included in the report by the MFP 100 was not detected by the measurement. Alternatively, based on previously measured information regarding the non-connected AP, the MFP 100 may perform processing to either respond with a low received signal strength, or respond with a value obtained by significantly increasing the noise strength. Alternatively, even when receiving the measurement request, the MFP 100 may respond regarding only the connected AP with a value indicating either a high received signal strength or a low noise strength, without actually performing measurement (AP search) and without including information regarding the non-connected AP. Thereby, the MFP 100 can report to the AP that the communication environment with the connected AP is favorable, and can reduce the possibility of receiving a connection target switching request. Responding to the measurement request without including information regarding the non-connected AP corresponds to content indicating that no other non-connected AP was found through an AP search. That is, responding without including information regarding the non-connected AP can be included in indicating that at least part of the signal quality from the non-connected AP is worse than that in a case where the AP search is actually performed.

As described above, as in Suppression Processing 2, by responding to the measurement request with information indicating a worse radio wave status (poorer signal quality) than the actually measured status, it can be expected that sending, from the connected AP, of a request to change the connection target to another AP is suppressed. Therefore, the change of the connection target in response to the change request is suppressed.

### Suppression Processing 3

In Suppression Processing 3, the MFP 100 disconnects from the connected AP once, provides information indicating that the MFP 100 does not support the change request, and reconnects to the same AP. Specifically, the MFP 100 terminates the wireless connection with the connected AP once, and creates data of an Association Request frame including information indicating that the MFP 100 does not support IEEE 802.11v as preparation for wireless reconnection. Thereafter, the MFP 100 performs processing to connect to the AP using the created data of the Association Request frame. As a result, in a case where the Association Request frame including information indicating that the MFP 100 does not support IEEE 802.11v is created, the MFP 100 connects to the AP as an electronic apparatus that does not support (is non-compliant with) the Agile Multiband function. As a result, the connected AP recognizes that the MFP 100 does not support IEEE 802.11v, and therefore the connected AP does not send a request to change the connection target to the MFP 100. Thus, the MFP 100 is no longer requested to change the wireless connection, and therefore it becomes easier to maintain the wireless connection between the MFP 100 and the connected AP. In addition, when the connected AP recognizes that the MFP 100 does not support IEEE 802.11v, transmission of the measurement request (the request described regarding S601) from the connected AP to the MFP 100 is also suppressed. Accordingly, it is also possible to suppress measurement (AP search) in response to a measurement request in the MFP 100, and a response to the measurement request (processing in step S603). Consequently, it is possible to reduce the processing load and the power consumption, and while the MFP 100 is executing other processing, processing resources can be allocated to the other processing.

Accordingly, while the MFP 100 is receiving print data, the MFP 100 can perform at least one of the above-described suppression processing 1 and suppression processing 2 as processing for suppressing a change of the connection target in response to a connection target change request. In addition, the MFP 100 can suppress a change of the connection target in response to a connection target change request by executing the above-described suppression processing 3 before starting to receive print data.

### Wireless Connection Setting Processing

As described above, in a case where the MFP 100 supports communication compliant with the IEEE 802.11v standard, the MFP 100 can perform communication by switching the AP to be connected from among a plurality of APs having the same ESSID, in response to a connection target change request transmitted from the AP 101. As a result, the MFP 100 can connect to an AP that provides a better communication environment. In the following description, a function of performing communication by switching the AP to be connected from among a plurality of APs having the same ESSID may be referred to as a Wi-Fi Agile Multiband function or an Agile Multiband (AMB) function. In the AMB function, a service set identifier (SSID) corresponds to an extended service set identifier (ESSID), and a media access control (MAC) address corresponds to a basic service set identifier (BSSID). An ESSID is an identifier that can be shared by a plurality of APs, and a BSSID is an identifier that cannot be shared by the APs.

Here, some users may execute wireless connection setting processing for setting a connection target AP without knowing the specifications of the automatic connection target change in communication compliant with the IEEE 802.11v standard. In such a case, the automatic connection target change by the AMB function cannot be performed, and the communication with an AP having a poor communication environment may continue even if an AP that provides a better communication environment exists.

In the present embodiment, in the wireless connection setting processing, the MFP 100 provides a predetermined display for prompting the user to use the AMB function when predetermined conditions are satisfied.

For example, the predetermined conditions include a condition that a plurality of APs having the same ESSID exist in the vicinity of the MFP 100. In the wireless connection setting processing, the MFP 100 receives beacon signals (wireless signals) transmitted from APs existing in the vicinity of the MFP 100, and detects the SSIDs and MAC addresses of the APs. At this time, when a plurality of APs having the same SSID are detected, the plurality of APs may be APs that can control the connection target of the MFP 100 in response to a connection target switching request, such as the AP 101 and the AP 102. In such a case, by providing the predetermined display, the user can be prompted to cause the MFP 100 to use the AMB function. In addition, the predetermined conditions may include a condition that, in the wireless connection setting processing, the ESSID of an AP designated as the connection target by the user is an ESSID shared with another AP.

In another example, the predetermined conditions include a condition that, in the wireless connection setting processing, an AP designated as the connection target by the user is an AP that supports the AMB function. When a beacon signal transmitted from an AP located in the vicinity includes a Capability field indicating the capability of the AP that transmitted the beacon signal, the MFP 100 can determine whether or not the AP supports the AMB function based on the beacon signal. When the AP supports the AMB function, the AP can transmit a connection target switching request to an electronic apparatus connected to the AP. In this case, when the AP designated as the connection target by the user is an AP that supports the AMB function, the MFP 100 can connect to an AP that provides a better communication environment in response to receiving a connection target switching request after the connection, by connecting to the AP using the AMB function. Note that, when the AP does not support the AMB function, the predetermined display may not be provided. Also, when the AP supports the AMB function but is operating with the AMB function disabled, the display for prompting the user to use the AMB function may not be provided. On the other hand, even when the AP supports the AMB function but is operating with the AMB function disabled, the user may be able to configure the AP and enable the AMB function. Therefore, when the AP supports the AMB function but is operating with the AMB function disabled, the display for prompting the user to use the AMB function may be provided.

In another example, the predetermined conditions include a condition that the AMB function is disabled despite the MFP 100 supporting the AMB function. For example, there is a case where the AMB function is disabled as a default setting of the MFP 100, or a case where the user disables the AMB function without understanding the specifications of the AMB function. In such a case, in the wireless connection setting processing, the MFP 100 can prompt the user to use the AMB function by prompting the user to enable the AMB function on the predetermined display.

In another example, the predetermined conditions include a condition that the MFP 100 supports the AMB function and the AMB function is enabled. In this case, by prompting the user to connect to an AP that supports the AMB function, the MFP 100 can perform communication using the AMB function.

Note that the above-described conditions can be combined in any manner. For example, when a plurality of APs having the same ESSID exist in the vicinity of the MFP 100, and the AMB function is disabled despite the MFP 100 supporting the AMB function, the predetermined display for prompting the user to enable the AMB function may be provided.

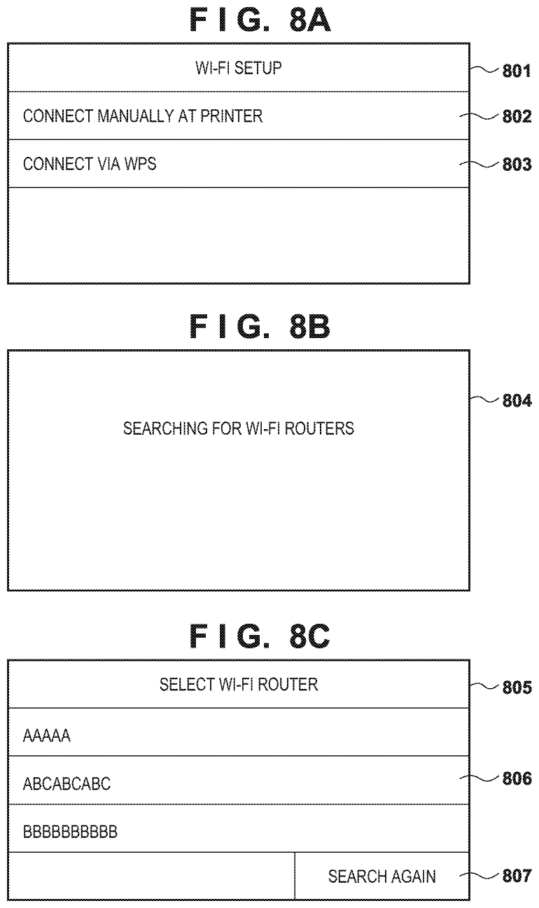

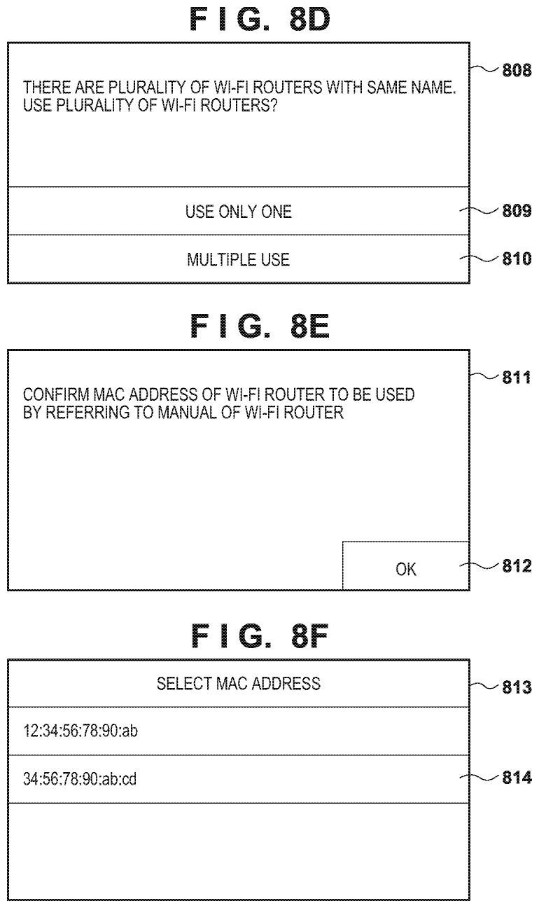

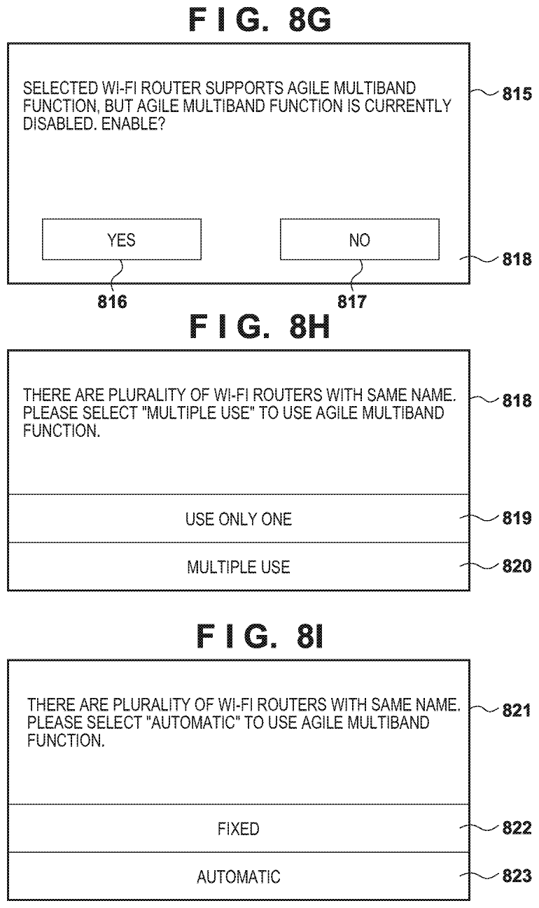

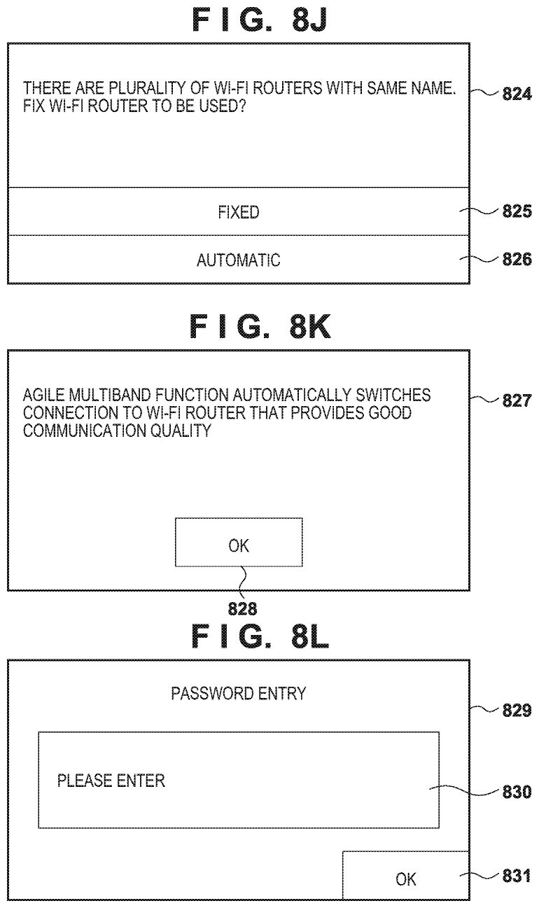

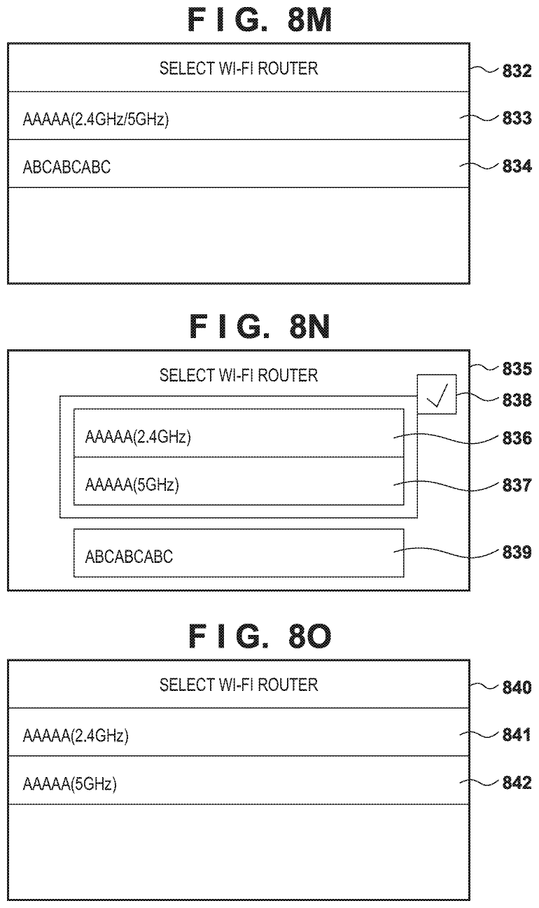

In addition, the predetermined display for prompting the user to use the AMB function includes at least one of the following displays to be described later with reference to FIGS. 8A to 8O.
(1) A display that, when connecting to a plurality of APs having the same SSID, prompts the user to select a second option on a screen for selecting either a first option for the user to designate a connection target from among the plurality of APs, or the second option for enabling the switching by the AMB function
(2) A display that prompts the user to enable the AMB function
(3) A display that, when selecting a connection target AP, enables the user to select a plurality of APs having the same ESSID

By providing any of the above-described displays, it is possible to prompt the user to use the AMB function.

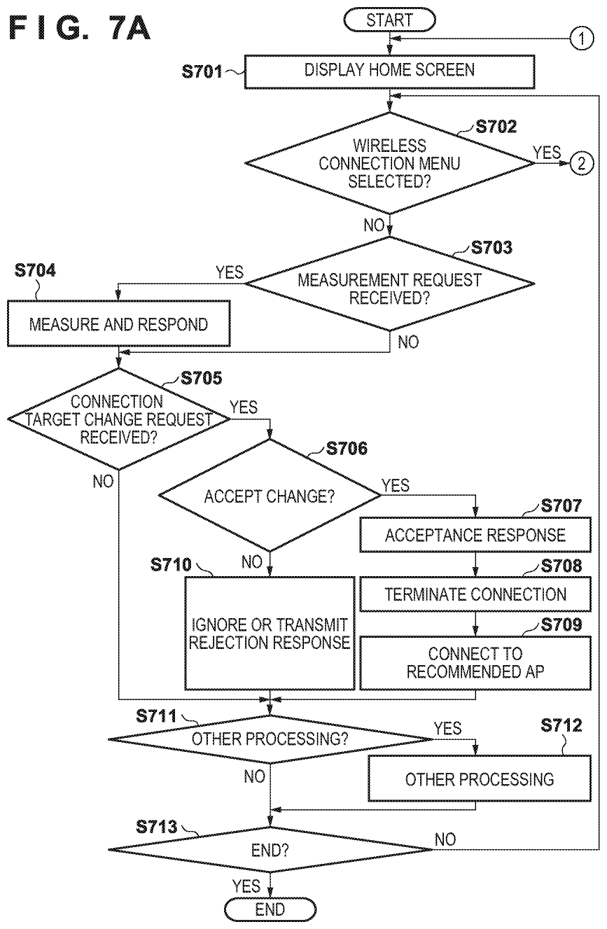

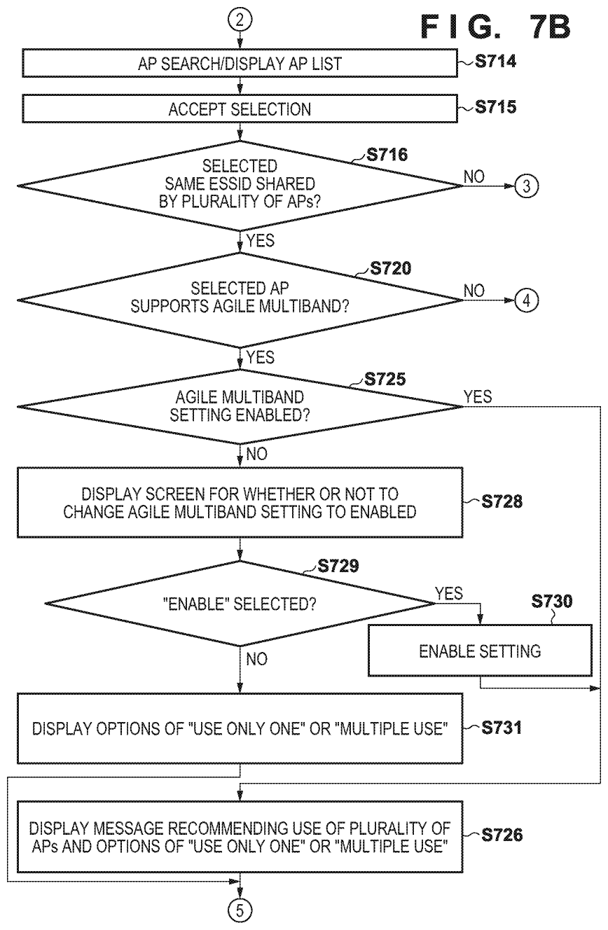

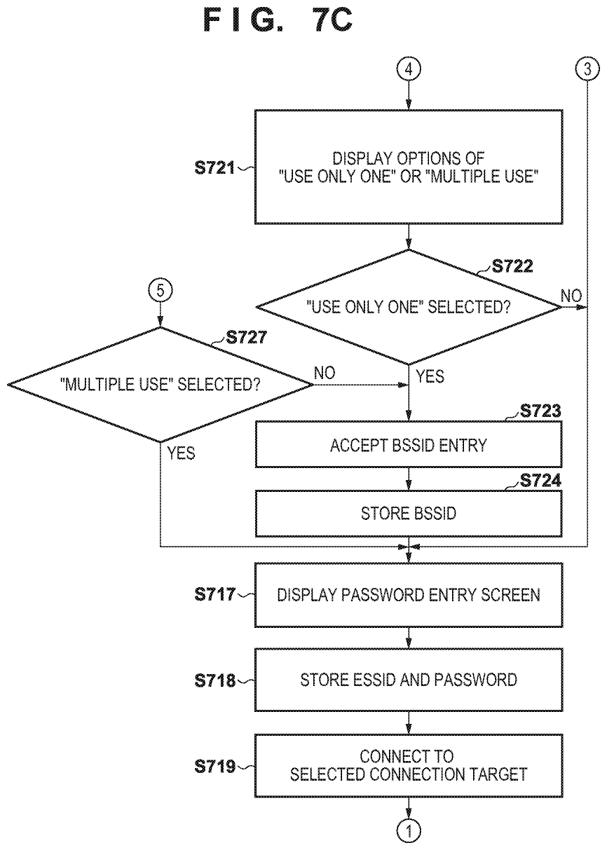

In the following description, an example of the wireless connection setting processing will be described with reference to FIGS. 3A to 3C, FIGS. 7A to 7C, and FIGS. 8A to 8O. The flowcharts in FIGS. 7A to 7C and examples of screen display in FIGS. 3A to 3C and FIGS. 8A to 8O represent a processing flow for providing displays on a screen when a plurality of APs having the same SSID are found through a search by the MFP 100 for APs in the vicinity thereof. The flowcharts shown in FIGS. 7A to 7C are started by the user turning on the power of the MFP 100 and the CPU 212 reading out and executing a computer program stored in the ROM 213.

In step S701, the MFP 100 displays a home screen on the display included in the operation display unit 220. The MFP 100 displays, for example, the screen shown in FIG. 3A as the home screen, and waits for an operation input from the user.

In step S702, if a menu for enabling the MFP 100 to establish a connection in the wireless infrastructure mode is not selected from the communication setting menu screen shown in FIG. 3C on the display included in the operation display unit 220 of the MFP 100, the processing proceeds to step S703.

In step S703, while the MFP 100 is connected to an AP, the MFP 100 determines whether or not a query (measurement request) regarding radio wave intensity of APs in the vicinity of the MFP 100 has been received. If a measurement request has been received, in step S704, the MFP 100 detects beacon signals (wireless signals) transmitted from the APs in the vicinity thereof, and responds to a request source with ESSIDs and BSSIDs included in the beacon signals and radio wave intensity information regarding the beacon signals.

In step S705, while the MFP 100 is connected to an AP, the MFP 100 determines whether or not a connection target change request (BTM Request) has been received. If the connection target change request has been received, the MFP 100 determines whether or not to accept the change in step S706, and if the change is to be accepted (Yes in step S706), an acceptance response is transmitted in step S707. In step S708, the current communication is terminated, and in step S709, processing to connect to a new AP is initiated. If the MFP 100 determines not to accept the change (No in step S706), the MFP 100 proceeds to step S710, and transmits a rejection response or does not respond (ignores the request).

While the MFP 100 is connected to an AP and is in a standby state in which the home screen is displayed in step S701, the MFP 100 checks in step S711 whether or not a selection of other processing has been made or data has been received. If another kind of processing has been selected or data has been received, the MFP 100 proceeds to step S712 and performs the corresponding processing. Examples of the other kind of processing include a case where print settings of the MFP 100 are changed based on a user input, and a case where maintenance of a print head is executed to maintain print quality of the MFP 100.

While the MFP 100 is connected to the AP 101 and is in the standby state in which the home screen is displayed in step S701, if the power-off of the MFP 100 is selected, the processing proceeds to step S713, and power-off processing is performed.

If a menu for establishing a connection in the wireless infrastructure mode is selected from the communication setting menu screen shown in FIG. 3C on a display included in the operation display unit 220 of the MFP 100 in step S702, the processing proceeds to step S714. In the present embodiment, a menu screen for initiating connection establishment in the wireless infrastructure mode is a display screen 801 shown in FIG. 8A. Areas 802 and 803 are displayed on the display screen 801, and if the user selects the area 802, the MFP 100 initiates a search for APs in the vicinity thereof. In the search for APs, SSIDs and MAC addresses included in beacon signals transmitted from the APs in the vicinity are detected. If the user selects the area 803, processing for establishing a connection with the MFP 100 is initiated by the user pressing a button of an AP designated as a connection target.

In step S714, APs in the vicinity are searched for, a list of the found APs is displayed on the operation display unit 220 as a search result, and in step S715, a selection from the list of the APs of an AP to which the user wishes to connect is accepted. In one example, a list of the SSIDs of the detected APs is displayed as the list of the APs. In the present embodiment, when the MFP 100 initiates a search for APs in the vicinity thereof, a display screen 804 shown in FIG. 8B is displayed. Thereafter, a display screen 805 shown in FIG. 8C is displayed as the list of the found APs. Areas 806 and 807 are displayed on the display screen 805, and the AP identification names (ESSIDs) of the found APs are displayed in the area 806. At this time, if a plurality of APs that have different basic service set identifiers (BSSIDs) and have the same ESSID are found, only one ESSID is displayed in the area 806 without displaying duplicate ESSIDs. Alternatively, duplicate ESSIDs are grouped for each communication channel and displayed in the area 806. When the user selects the area 807, a search for APs in the vicinity is performed again.

In step S716, the MFP 100 determines whether or not the selected ESSID is an ESSID shared by a plurality of APs. For example, if beacon signals indicating the same ESSID are received from a plurality of APs having different BSSIDs within a predetermined time period during which the search for APs is performed, it can be determined that the same ESSID is used among the plurality of APs. Here, if the selected ESSID is not an ESSID shared by a plurality of APs (No in step S716), the MFP 100 causes the processing to proceed to step S717.

In step S717, the MFP 100 displays on the operation display unit 220 a password entry screen used for connecting to the AP having the selected ESSID, and waits for a password entry from the user. In the present embodiment, the MFP 100 displays a display screen 829 shown in FIG. 8L as the screen for waiting for a password entry from the user. Areas 830 and 831 are displayed on the display screen 829, and when the user selects the area 830, password entry is initiated, and when the user selects the area 831, the password entry is completed and the processing proceeds to step S718.

In step S718, the MFP 100 stores, in the nonvolatile memory 215, the ESSID information selected by the user in step S715 and the password information entered by the user in step S717. Subsequently, in step S719, the MFP 100 attempts to connect to the AP corresponding to the ESSID selected by the user in step S715, using the password entered by the user in step S717.

In step S716, if it is determined that the selected ESSID is an ESSID shared by a plurality of APs, the CPU 212 causes the processing to proceed to step S720.

In step S720, it is determined whether or not at least any one of the APs selected by the user in step S715 supports Wi-Fi Agile Multiband. If it is determined that the selected APs do not support Wi-Fi Agile Multiband (No in step S720), the MFP 100 causes the processing to proceed to step S721. Whether or not the APs support Wi-Fi Agile Multiband can be determined from capability information included in beacon signals received when the search for APs in the vicinity was performed in step S714.

In step S721, a selection screen is displayed on the operation display unit 220, including an option to connect to an AP with a specific BSSID among the plurality of APs having the selected ESSID and an option to connect to the plurality of APs having different BSSIDs in a switchable manner, and a user selection is awaited.

In the present embodiment, a display screen 808 shown in FIG. 8D is displayed as the above-described screen. Areas 809 and 810 are displayed on the display screen 808, and when the user selects the area 809, it is determined that the user has selected to connect only to a specific AP. In this case, the user inputs the BSSID in the processing in step S721 and the subsequent processing. In other words, the area 809 is a first option for the user to designate a connection target among the plurality of APs having the same ESSID (SSID). The first option is an option (first option) for providing an instruction to connect to an AP without using Wi-Fi Agile Multiband.

On the other hand, when the user selects the area 810, it is determined that the user has selected to connect to the plurality of APs having the selected ESSID in a switchable manner. In the case of connecting to the plurality of APs having the selected ESSID in a switchable manner, the connection target AP is changed in accordance with a measurement request and a connection target change request from an AP by a mechanism compliant with Wi-Fi Agile Multiband. On the other hand, in the case of connecting only to a specific AP, the connection to the AP is established by a mechanism not compliant with Wi-Fi Agile Multiband. In other words, the area 810 is an option (second option) for connecting to the plurality of APs having the same ESSID in a switchable manner by the Wi-Fi Agile Multiband function.

Note that, if the AMB function is disabled in the MFP 100, the area 810 may be grayed out so as not to be selectable in step S721. Alternatively, if the AMB function is disabled, when the area 810 is selected in step S721, a display for prompting the user to enable the AMB function may be provided. Alternatively, if the AMB function is disabled, when the area 810 is selected in step S721, the AMB function may be enabled.

As a modification, a display screen 824 shown in FIG. 8J may be displayed. In the display screen 824, areas 825 and 826 are displayed, and when the user selects the area 825, it is determined that the user has selected to connect only to an AP having a fixed BSSID. In contrast, when the user selects the area 826, it is determined that the user has selected to connect to a plurality of APs having different BSSIDs by using the Wi-Fi Agile Multiband function while automatically switching the connection among them. That is, in FIG. 8J, the area 825 corresponds to the above-described first option, and the area 826 corresponds to the above-described second option.

In one example, in the screens shown in FIGS. 8D and 8J, a display for prompting the user to select the second option may be provided. For example, the display may be a message such as “Please select ‘Multiple Use’ to use the Agile Multiband function”. Alternatively, the second option may be highlighted as a default option.

For example, there is a case where the connection target AP appears not to support the AMB function based on Capability information because the AMB function is disabled, despite the AP supporting the AMB function. In this case, if the AMB function is enabled on the MFP 100 side by selecting the second option, communication using the AMB function can be performed when the AMB function of the connection target AP is enabled.

In step S722, if the user enables the switching of the connection target among the plurality of APs using the AMB function, that is, if the user selects the second option (No in S722), the CPU 212 proceeds the processing to step S717. In step S722, if the user selects to connect to an AP having a fixed BSSID, that is, if the user selects the first option (Yes in S722), the CPU 212 proceeds the process to step S723. In step S723, the MFP 100 displays a list of BSSIDs (MAC addresses) of the plurality of APs having the same ESSID on the operation display unit 220, and prompts the user to select a connection target AP. In the present embodiment, if the user selects to connect to a fixed AP (Yes in S722), a display screen 811 shown in FIG. 8E is displayed to prompt the user to select the BSSID of the AP to which the user wishes to connect. An area 812 is displayed on the display screen 811, and when the user selects the area 812, a display screen 813 shown in FIG. 8F is displayed. An area 814 is displayed on the display screen 813, and in the area 814, a list of the BSSIDs of APs is displayed, and the user can select the BSSID of an AP to which the user wishes to connect. In another example, the user may use an input interface such as a keypad to input the BSSID of the AP to which the user wishes to connect.

After the user selects a BSSID in step S723, the CPU 212 proceeds the processing to step S724, stores information regarding the selected BSSID in the nonvolatile memory 215, and causes the processing to transition to step S717.

Note that, if the first option is selected in step S727, the MFP 100 may disable the AMB function.

As for the operation for connecting to a plurality of APs having different BSSIDs, for example, in a state where the MFP 100 is connected to an AP, when the connection with the AP is terminated due to some factor, the MFP 100 performs processing for reconnection. In the reconnection processing, the MFP 100 searches for APs in the vicinity thereof, and when there are a plurality of APs having different BSSIDs and having the same ESSID as the ESSID stored in the nonvolatile memory 215, the MFP 100 measures the radio wave intensity of each of the APs and connects to an AP having higher radio wave intensity than others. At this time, the connected AP may be the AP to which the MFP 100 was originally connected, or may be a different AP. Note that, when connecting to an AP having a fixed BSSID, the MFP 100 searches for APs in the vicinity thereof, and even if there are a plurality of APs having the same ESSID as the ESSID stored in the nonvolatile memory 215, the MFP 100 continues to connect to the AP regardless of the level of radio wave intensity. Note that, in Wi-Fi Agile Multiband, a password for connecting to an AP is common. Therefore, even when connecting to a different AP, the password that was used to connect to the AP before the switching can be used.

In step S720, when it is determined that the AP selected by the user supports the AMB function, the CPU 212 proceeds the processing to step S725 and determines whether or not the AMB function of the MFP 100 is enabled. Here, if the AMB function of the MFP 100 is enabled, the MFP 100 sets a BSS Transition Support flag in the Association Request in the processing to connect to an AP, and connects to the AP. In this case, the MFP 100 can receive the inquiry regarding the radio wave intensity of APs in the vicinity of the MFP 100 in step S601 and the request to change the connection target AP (BSS Transition Management (BTM) Request) in step S605 in FIG. 6, from the AP. Further, when the Wi-Fi Agile Multiband function of the MFP 100 is disabled, in the processing to connect to an AP, the MFP 100 clears a BSS (Basic Service Set) Transition Support flag in the Association Request and connects to the AP. In this case, the MFP 100 cannot receive the inquiry regarding the radio wave intensity of APs in the vicinity of the MFP 100 in step S601 and the request to change the connection target AP (BTM Request) in step S605 in FIG. 6.

In step S725, when it is determined that the Wi-Fi Agile Multiband function of the MFP 100 is enabled, the CPU 212 transitions the processing to step S726.

In step S726, in addition to the options described in step S721, the CPU 212 displays on the operation display unit 220 a screen for recommending that the user select to connect to one or more APs in a switchable manner because the AP supports Wi-Fi Agile Multiband. In the present embodiment, a display screen 818 shown in FIG. 8H is displayed as the above-described screen. Areas 819 and 820 are displayed on the display screen 818. When the user selects the area 819, it is determined that the user has selected to connect only to a specific AP. On the other hand, when the user selects the area 820, it is determined that the user has selected to connect to a plurality of APs having the selected ESSID in a switchable manner. That is, in the area 819, the first option for the user to designate a connection target among the plurality of APs is displayed, and in the area 820, the second option for enabling the switching of a connection target among the plurality of APs using the AMB function is displayed. Further, on the display screen 818, by displaying a message such as “Please select ‘Multiple Use’ to use the Agile Multiband function”, it is possible to prompt the user to select an option to enable the MFP 100 to switch a connection target among a plurality of APs having the same ESSID.

As a modification of FIG. 8H, a display screen 821 in FIG. 8I may be displayed. Areas 822 and 823 are displayed on the display screen 821, and when the user selects the area 822, it is determined that the user has selected to connect only to an AP having a fixed BSSID. On the other hand, when the user selects the area 823, it is determined that the user has selected to connect to a plurality of APs having the same ESSID and having different BSSIDs. That is, in the area 822, the first option for the user to designate a connection target among the plurality of APs is displayed, and in the area 823, the second option for enabling the switching of a connection target among the plurality of APs using the AMB function is displayed. On the display screen 821, by displaying a message such as “Please select ‘Automatic’ to use the Agile Multiband function”, it is possible to prompt the user to select to enable the MFP 100 to connect to a plurality of APs having the same ESSID in a switchable manner.

In step S727, when the user selects to connect to a plurality of APs having the same ESSID and different BSSIDs, the CPU 212 transitions the processing to step S717 and displays a password entry screen on the operation display unit 220. The password entry screen displayed in step S717 is similar to the display screen 829 shown in FIG. 8L. Since the display screen 829 in FIG. 8L has been described above, the description thereof will be omitted. Further, as a different embodiment, in a case where the user selects to connect to a plurality of APs, a display screen 827 in FIG. 8K may be displayed before the display screen 829 in FIG. 8L is displayed. On the display screen 827, it is explained to the user that the Agile Multiband function is available. An area 828 is displayed on the display screen 827, and when the user selects the area 828, the display screen 829 shown in FIG. 8L, which is a password entry screen, is displayed.

In step S727, when the user selects to connect to an AP with a specific BSSID, the CPU 212 transitions the processing to step S723, displays a list of the BSSIDs of the APs, and prompts the user to select the BSSID of the connection target AP. In the present embodiment, the display screen 811 shown in FIG. 8E is displayed as the list of the BSSIDs of the APs. Since the display screen 811 in FIG. 8E has been described above, the description thereof will be omitted.

In step S725, when it is determined that the Wi-Fi Agile Multiband function of the MFP 100 is disabled, the CPU 212 transitions the processing to step S728. In step S728, the CPU 212 displays on the operation display unit 220 a screen for prompting the user to select whether or not to change the setting of the Agile Multiband function of the MFP 100 from disabled to enabled. In the present embodiment, a display screen 815 shown in FIG. 8G is displayed as a screen for confirming with the user whether or not to enable the Agile Multiband function of the MFP 100. An area 816 and an area 817 are displayed on the display screen 815, and when the user selects the area 816, it is determined that the user has selected to enable the Agile Multiband function. When the user selects the area 817, it is determined that the user has selected not to change the setting of the Agile Multiband function of the MFP 100 from disabled. In one example, in FIG. 8G, a display prompting the user to select a setting to enable the Agile Multiband function may be provided. For example, in FIG. 8G, by displaying a message such as “By enabling the Agile Multiband function, communication will be automatically switched to an AP that provides a good communication environment”, the user can select to enable the Agile Multiband function.

In step S729, when the user selects to enable the Agile Multiband function of the MFP 100, the CPU 212 updates the setting in step S730, stores the setting value in the nonvolatile memory 215, and transitions the processing to step S726. In step S729, when the user selects not to change the setting to enable the Wi-Fi Agile Multiband function of the MFP 100, the CPU 212 transitions the processing to step S731.

In step S731, the CPU 212 displays on the operation display unit 220 a screen for prompting the user to select whether or not to connect only to an AP having a specific BSSID or to connect to a plurality of APs having the same ESSID and different BSSIDs. In the present embodiment, since the screen displayed in step S731 is similar to the screen displayed in step S721, the description thereof will be omitted.

In the screen displayed in S731, since the AMB function is disabled, selection of the “Multiple Use” option may be suppressed by, for example, graying out the “Multiple Use” option. Alternatively, the “Multiple Use” option may be displayed in a selectable manner, and when selected, the user may be prompted to enable the AMB function again as in step S728.

In the present embodiment, although the display screen 805 shown in FIG. 8C is described as being displayed as a screen for displaying search results of APs in step S714, a different screen may be displayed. For example, in step S714, before searching for APs in the vicinity, the CPU 212 may check whether or not the AMB function of the MFP 100 is enabled as described with reference to step S725. Here, if the AMB function is enabled and a plurality of APs having the same ESSID are detected in the search for APs, a screen 832 shown in FIG. 8M may be displayed. An area 833 and an area 834 are displayed on the screen 832, and the ESSID and frequency bands corresponding to the plurality of APs having different BSSIDs are displayed in the area 833. When an ESSID corresponding to a plurality of APs having different BSSIDs is not detected, only a single ESSID is displayed as in the area 834.

Further, as a different example of screen display in a case where the AMB function of the MFP 100 is enabled and the same ESSID for a plurality of APs having different BSSIDs is detected in the search for APs, the CPU 212 may display a screen 835 shown in FIG. 8N. Areas 836, 837, 838, and 839 are displayed on the screen 835. The area 836 and the area 837 display the same ESSID and respective frequency bands for the plurality of APs. By selecting the area 838, the user can collectively select the plurality of APs having the same ESSID. When the same ESSID for a plurality of APs is not detected in the search for APs, the CPU 212 displays only an ESSID corresponding to a single AP as in the area 839.

In this way, by making a plurality of APs collectively selectable, it is possible to prompt the user to use the AMB function when the user does not know which AP to connect to. Note that, a display prompting selection of a plurality of APs may be provided on the screen 835 as well. For example, by displaying a message such as “Please select multiple channels together to use the Agile Multiband function” on the screen 835, it is possible to prompt the user to select the area 838.

When the same ESSID for a plurality of APs is detected in the search for APs and the AMB function of the MFP 100 is disabled, the CPU 212 displays a screen 840 shown in FIG. 8O. The screen 840 includes an area 841 and an area 842, and the area 841 and the area 842 display the same ESSID and respective frequency bands for the plurality of APs. Here, the screens shown in FIGS. 8M, 8N, and 8O are displayed depending on whether the Wi-Fi Agile Multiband function of the MFP 100 is enabled or disabled and whether the same ESSID for a plurality of APs is detected in the search for APs. However, in addition to the above-described conditions, the display screen may be switched based on whether or not the AP supports the AMB function or based on another condition.

As described above, according to the present embodiment, when the MFP 100 searches for APs in the vicinity thereof, it is determined whether or not the MFP 100 supports the AMB function, and appropriate screens are displayed. With this configuration, when the MFP 100 supports the AMB function, it is possible to recommend that the user enables the AMB function, thereby allowing the user to connect to an AP that provides a good communication environment.

Note that the above-described control, in which a BSSID (MAC address) is designated via the operation display unit 220 of the MFP 100, may be modified such that the designation of a BSSID (MAC address) is accepted from an external apparatus.

The various types of control described above as performed by the MFP 100 may be performed by a single piece of hardware, or a plurality of pieces of hardware (e.g., a plurality of processors or circuits) may share the processing to control the entire device.

In addition, although the present disclosure has been described in detail based on the preferred embodiments thereof, the present disclosure is not limited to these specific embodiments, and the present disclosure also includes various forms without departing from the spirit of the present disclosure. Furthermore, each of the embodiments described above is merely an embodiment of the present disclosure, and it is also possible to combine the embodiments as appropriate.

Although the above-described embodiments describe an example in which the present disclosure is applied to the MFP 100, the present disclosure is not limited to this example, and the present disclosure is applicable to any wireless device that functions as an STA capable of performing processing in response to a connection target change request from an AP. That is to say, the present disclosure is applicable to personal computers, PDAs, tablet terminals, mobile phone terminals such as smartphones, music players, game consoles, electronic book readers, smart watches, and various measuring devices (sensor devices) such as thermometers and hygrometers. Furthermore, the present disclosure is applicable to digital cameras (including still cameras, video cameras, network cameras, and security cameras), printers, scanners, and drones. Furthermore, the present disclosure is applicable to video output devices, audio output devices (for example, smart speakers), media streaming players, wireless LAN adapter devices (adapters) that can be connected to USB terminals or LAN cable terminals, and so on. Examples of video output devices include a device that realizes streaming playback on a display device or mirroring display (displaying the content displayed on an electronic device also on a display device) by acquiring (downloading) a video on the Internet specified by a URL designated by an electronic device and outputting the video to a display device connected via a video output terminal such as HDMI (registered trademark). Examples of video output devices also include a television, a media player such as a hard disk recorder, a Blu-ray recorder, a DVD recorder, a head-mounted display, a projector, a television, a display device (monitor), a signage device, and so on. The present disclosure is also applicable to Wi-Fi connectable devices called smart home appliances, such as air conditioners, refrigerators, washing machines, vacuum cleaners, ovens, microwave ovens, lighting equipment, heating equipment, cooling equipment, and so on.

As described above, by changing the content of a measurement result to be transmitted in response to a measurement request from the AP according to the processing status of the MFP 100, it is possible to appropriately control the timing of switching the AP.

### Other Embodiments

In the present embodiment, the description has been given assuming that the user operates the MFP 100 to connect to an AP. In one example, the user may connect the MFP 100 to an AP via an information processing apparatus such as the mobile terminal device 104. In such a case, the mobile terminal device 104 may establish a wireless direct connection with the MFP 100, transmit to the MFP 100 a measurement request requesting measurement of beacon signals transmitted from APs in the vicinity of the MFP 100, and acquire a list of ESSIDs and BSSIDs of the APs in the vicinity of the MFP 100. In this case, when displaying the list of ESSIDs and BSSIDs of the APs in the vicinity on the display unit 420, the mobile terminal device 104 may perform control to display the screens described with reference to FIGS. 8A to 8O. For example, when selecting a connection target AP of the MFP 100, if a plurality of APs having the same SSID are selected, or if a plurality of APs having the same SSID are included in the list, the mobile terminal device 104 may display the above-described first option and second option. Further, the mobile terminal device 104 may provide a display prompting the user to select the second option. Further, on a screen for selecting a connection target AP of the MFP 100, the mobile terminal device 104 may group and display a plurality of APs having the same SSID, or group and display them for each frequency band to be used.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electronic apparatus comprising:
at least one memory and at least one processor which function as:
a communication control unit configured to perform control to change a connection target access point (AP) based on receiving, from a currently connected AP, a connection target change request for changing a connection target;
a detection unit configured to detect service set identifiers (SSIDs) of APs in a vicinity based on wireless signals received from the APs in the vicinity; and
a display control unit configured to, when a connection target AP is to be set, in a case where one or more predetermined conditions including a condition that a plurality of APs having the same SSID are detected by the detection unit are satisfied, perform control to display a selection screen for selecting between a first option for a user to designate a connection target from among the plurality of APs, and a second option for enabling the communication control unit to switch the connection target among the plurality of APs,
wherein the display control unit provides a predetermined display on the selection screen to prompt the user to select the second option.

2. The electronic apparatus according to claim 1,
wherein the detection unit further detects, based on wireless signals received from the APs in the vicinity, whether or not at least one AP among the APs in the vicinity is capable of transmitting the connection target change request, and
when a connection target AP is to be set, the display control unit performs control to provide the predetermined display if the detection unit detects at least one AP capable of transmitting the connection target change request, and not to provide the predetermined display if the detection unit detects no AP capable of transmitting the connection target change request.

3. The electronic apparatus according to claim 1,
wherein, when a connection target AP is to be set, the display control unit accepts selection of an SSID of the connection target AP, and
the display control unit provides the predetermined display if a plurality of APs having the same SSID are selected as the connection target AP, and does not provide the predetermined display if a plurality of APs having the same SSID are not selected as the connection target AP.

4. The electronic apparatus according to claim 3,
wherein the detection unit further detects, based on wireless signals received from the APs in the vicinity, whether or not at least one AP among the APs in the vicinity is capable of transmitting the connection target change request, and
when a connection target AP is to be set and a plurality of APs having the same SSID are selected as the connection target AP, the display control unit performs control to provide the predetermined display if at least one AP among the plurality of APs is capable of transmitting the connection target change request, and not to provide the predetermined display if none of the plurality of APs is capable of transmitting the connection target change request.

5. The electronic apparatus according to claim 1,
wherein the at least one memory and the at least one processor further function as a setting unit configured to set whether or not to enable a function of changing a connection target by the communication control unit, and
the one or more predetermined conditions include a condition that the function is enabled by the setting unit.

6. The electronic apparatus according to claim 5,
wherein the detection unit further detects, based on wireless signals received from the APs in the vicinity, whether or not at least one AP among the APs in the vicinity is capable of transmitting the connection target change request, and
when a connection target AP is to be set, the display control unit performs control to provide a display that suppresses selection of the second option on the selection screen in a case where a plurality of APs having the same SSID are detected by the detection unit, at least one AP among the plurality of APs is capable of transmitting the connection target change request, and the function is disabled by the setting unit.

7. The electronic apparatus according to claim 5,
wherein when a connection target AP is to be set, the display control unit performs control to provide a display that prompts the user to enable the function in a case where a plurality of APs having the same SSID are detected by the detection unit, at least one AP among the plurality of APs is capable of transmitting the connection target change request, and the function is disabled by the setting unit.

8. The electronic apparatus according to claim 5,
wherein, in a case where the first option is selected on the selection screen, the display control unit accepts designation of an identifier corresponding to one of the plurality of APs, and the setting unit performs control to disable the function.

9. The electronic apparatus according to claim 5,
wherein the at least one memory and the at least one processor further function as a transmission unit configured to transmit information including an SSID of an AP detected by the detection unit to an information processing apparatus communicable on the same network as the electronic apparatus,
in response to receiving, from the information processing apparatus, a measurement request for detecting SSIDs of APs in a vicinity, the detection unit detects the SSIDs of the APs in the vicinity based on wireless signals received from the APs in the vicinity,
the information processing apparatus includes
at least one memory and at least one processor which function as:
a display control unit configured to, in a case where a plurality of APs having the same SSID are detected based on the information received from the electronic apparatus, perform control to display a second selection screen for selecting between a third option for the user to designate a connection target from among the plurality of APs, and a fourth option for enabling the communication control unit to switch the connection target among the plurality of APs; and
a second transmission unit configured to transmit information corresponding to an option selected on the second selection screen to the electronic apparatus, and
the second selection screen includes a display that prompts the user to select the fourth option.

10. The electronic apparatus according to claim 9,
wherein, in a case where information corresponding to the third option is received from the information processing apparatus, the setting unit performs control to disable the function.

11. The electronic apparatus according to claim 1,
wherein, when a connection target AP is to be set, the display control unit accepts selection of an SSID of the connection target AP, and
in a case where the one or more predetermined conditions are satisfied, the display control unit performs control to display a connection target AP selection screen such that the plurality of APs having the same SSID are collectively selectable as the connection target AP.

12. An electronic apparatus comprising:
at least one memory and at least one processor which function as:
a communication control unit configured to perform control to change a connection target access point (AP) based on receiving, from a currently connected AP, a connection target change request for changing a connection target;
a detection unit configured to detect service set identifiers (SSIDs) of APs in a vicinity based on wireless signals received from the APs in the vicinity; and
a display control unit configured to, when a connection target AP is to be set, in a case where one or more predetermined conditions including a condition that a plurality of APs having the same SSID are detected by the detection unit are satisfied, perform control to display a connection target AP selection screen such that the plurality of APs having the same SSID are collectively selectable as the connection target AP.

13. An electronic apparatus comprising:
at least one memory and at least one processor which function as:
a communication control unit configured to perform control to change a connection target access point (AP) based on receiving, from a currently connected AP, a connection target change request for changing a connection target;
a setting unit configured to set whether to enable or disable a function of changing a connection target AP by the communication control unit;
a detection unit configured to detect service set identifiers (SSIDs) of APs in a vicinity based on wireless signals received from the APs in the vicinity; and
a display control unit configured to, when a connection target AP is to be set, in a case where one or more predetermined conditions including a condition that a plurality of APs having the same SSID are detected by the detection unit are satisfied, perform control to display a predetermined screen that prompts a user to enable the function.

14. The electronic apparatus according to claim 13,
wherein the display control unit performs control to display the predetermined screen if the function is disabled by the setting unit, and not to display the predetermined screen if the function is enabled by the setting unit.

15. The electronic apparatus according to claim 13,
wherein the detection unit further detects, based on wireless signals received from the APs in the vicinity, whether or not at least one AP among the APs in the vicinity is capable of transmitting the connection target change request, and
when a connection target AP is to be set, the display control unit performs control to display the predetermined screen in a case where the detection unit detects a plurality of APs having the same SSID, and the detection unit detects at least one AP capable of transmitting the connection target change request.

16. The electronic apparatus according to claim 15,
wherein, in a case where the function is enabled by the setting unit, the display control unit displays a selection screen for selecting between a first option for the user to designate a connection target from among the plurality of APs, and a second option for enabling the communication control unit to switch the connection target among the plurality of APs, and
the display control unit provides a display on the selection screen to prompt the user to select the second option.

17. A control method carried out by an electronic apparatus, comprising:
a communication control step of performing control to change a connection target access point (AP) based on receiving, from a currently connected AP, a connection target change request for changing a connection target;
a detection step of detecting service set identifiers (SSIDs) of APs in a vicinity based on wireless signals received from the APs in the vicinity; and
a display control step of, when a connection target AP is to be set, in a case where one or more predetermined conditions including a condition that a plurality of APs having the same SSID are detected are satisfied, performing control to display a selection screen for selecting between a first option for a user to designate a connection target from among the plurality of APs, and a second option for enabling switching of the connection target among the plurality of APs in the communication control step,
wherein the selection screen includes a specific display for prompting the user to select the second option.

18. A control method carried out by an electronic apparatus, comprising:
a communication control step of performing control to change a connection target access point (AP) based on receiving, from a currently connected AP, a connection target change request for changing a connection target;
a detection step of detecting service set identifiers (SSIDs) of APs in a vicinity based on wireless signals received from the APs in the vicinity; and
a display control step of, when a connection target AP is to be set, in a case where one or more predetermined conditions including a condition that a plurality of APs having the same SSID are detected are satisfied, performing control to display a connection target AP selection screen such that the plurality of APs having the same SSID are collectively selectable as the connection target AP.

19. A control method carried out by an electronic apparatus, comprising:
a communication control step of, based on receiving, from a currently connected AP, a connection target change request for changing a connection target, controlling connection with the AP;
a setting step of setting whether to enable or disable a function of changing a connection target based on the connection target change request;
a detection step of detecting service set identifiers (SSIDs) of APs in a vicinity based on wireless signals received from the APs in the vicinity; and
a display control step of, when a connection target AP is to be set, in a case where one or more predetermined conditions including a condition that a plurality of APs having the same SSID are detected are satisfied, performing control to display a screen that prompts a user to enable the function.

20. A non-transitory computer-readable storage medium having recorded thereon a program for enabling a computer to execute a control method carried out by an electronic apparatus, the method comprising:
a communication control step of performing control to change a connection target access point (AP) based on receiving, from a currently connected AP, a connection target change request for changing a connection target;
a detection step of detecting service set identifiers (SSIDs) of APs in a vicinity based on wireless signals received from the APs in the vicinity; and
a display control step of, when a connection target AP is to be set, in a case where one or more predetermined conditions including a condition that a plurality of APs having the same SSID are detected are satisfied, performing control to display a selection screen for selecting between a first option for a user to designate a connection target from among the plurality of APs, and a second option for enabling switching of the connection target among the plurality of APs in the communication control step,
wherein the selection screen includes a specific display for prompting the user to select the second option.
